(19) United States
(12) Patent Application Publication
(10) Pub. No.: US 2022/0026609 A1
(43) Pub. Date: Jan. 27, 2022

(54) Fast Making of Transparent Angularly Selective Polymer Films and Plates

(71) Applicant: AGENCY FOR SCIENCE, TECHNOLOGY AND RESEARCH, Singapore (SG)

(72) Inventor: FuKe Wang, Singapore (SG)

(21) Appl. No.: 17/311,384

(22) PCT Filed: Dec. 17, 2019
(86) PCT No.: PCT/SG2019/050620

§ 371 Date: Jun. 7, 2021

(51) Int. Cl. G02B 5/18; G02B 1/04

(52) U.S. Cl. CPC G02B 5/1857; B05D 3/067; G02B 1/04; G02B 5/1866

(57) ABSTRACT

A method fabricates a transparent polymer plate or film. The method incudes applying an acrylate ink to a transparent substrate and illuminating the polymeric substrate and the acrylate ink with a light source to cause photopolymerization. The photopolymerization creates micro-louvre structures inside the transparent polymeric plate or film.

### TECHNICAL FIELD

The present invention generally relates to methods and apparatus for fast making of transparent angularly selective polymer films and plates.

### BACKGROUND OF THE DISCLOSURE

The ability to control light has long been a major scientific and technological goal. For the electromagnetic wave, the electromagnetic plane wave is characterized by its frequency, polarization, and propagation direction. The ability to select light according to each of these separate properties would be an essential step in achieving control over light. An angularly selective system or light selective scattering should ideally work over a broadband spectrum. Such a system could potentially play a crucial role in many applications, such as high efficiency solar energy conversion, privacy protection, and detectors with high signal-to-noise ratios.

Traditional broadband angularly selective systems are mainly based on geometrical optics. The traditional angularly selective system generally comprises of a transparent polymeric material as the base sheet and light directing elements comprising absorptive material. Each element serves as light shade with width (w), height (h), and distance (a) away from each other. In the micro-louvre design, w, h and a are all in the range from 5 μm to 50 μm. Human eyes cannot see the micro-louvre components, but they are still much bigger than the wavelength of the visible light.

One reflective broadband angularly selective filter is based on microscale geometrical optics. When these optics include parabolic directors designed with 22 μm height and 10 μm diameter, they exhibit a strong angular selectivity. Light with incident angle less than 5.6° is able to funnel through the system, while light incident at larger angles is strongly reflected. The parabolic light director is fabricated using two-photon lithography, thin film processing, and aperture formation by focused ion beam lithography.

One schematic layout combines polarizers and birefringent films to achieve broadband angular selectivity. The schematic layout includes a half wave plate or birefringent film sandwiched between two polarizers and that are crossed at 90°. When the light passes through the first polarizer and the birefringent film, the polarization axis of the light is rotated appreciably. The rotation of the polarization axis is proportional to the distance of the light traveling in the birefringent film. The degree of birefringence and the thickness of the birefringent film are selected so that all orthogonal light has its polarizing axis rotated by 90° after passing through the birefringent film, while non-orthogonal light has its polarizing axis rotated by a different angle. In this way, all orthogonal light will transmit through the second polarizer while the non-orthogonal light will be substantially blocked by the second polarizer.

Most of the angularly selective systems have been based on geometrical optics approaches, which are usually bulky and expensive. In addition, the micro louvered layers are thin polymer film, they are subject to distortion from physical stress and temperatures. The skiving by which the louvered plastic films are produced results in irregular surfaces that prevent the skived plastic films from transmitting a clear optic image. Mostly importantly, the process of laminating louvered plastic films between two clear films requires an expensive press, and the resulting laminates cannot be larger than the platens of the press machine in which they are laminated. These conventional processes seriously limit the applications of the privacy film. Therefore, there is a strong need to develop a new technique to fabricate large area of broadband angularly selective films and plates to broaden their applications.

### SUMMARY

Example embodiments include methods and apparatus for fast making of transparent angularly selective polymer films and plates. The microstructures of the polymers are fast formed during the photopolymerization process and have broadband angularly selectivity.

One example embodiment is a method to make a transparent polymer film. The method includes coating a transparent polymeric substrate with an acrylate ink; adjusting a distance between a light source and the transparent polymeric substrate; and illuminating the transparent polymeric substrate and the acrylate ink with the light source to cause photopolymerization that creates the transparent polymer film with micro-louvre components inside the transparent polymer film.

Another example embodiment is a method to make a transparent polymer plate. The method includes applying an acrylate ink to a glass substrate; and illuminating the glass substrate and the acrylate ink with a light source to cause photopolymerization that creates the transparent polymer plate with micro-louvre structures inside the transparent polymeric plate.

Another example embodiment is a transparent polymer film fabricated from the method that comprises applying an acrylate ink to a Poly(methyl methacrylate) (PMMA) substrate; adjusting a distance between a light source and the PMMA substrate; adjusting an angle between the light source and the PMMA substrate; and illuminating the PMMA substrate and the acrylate ink with the light source to cause photopolymerization that forms micro-louvre components on a surface of the PMMA substrate.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with example embodiments.

FIG. 1 is a flowchart of method to fabricate a transparent polymer film and/or plate with broadband angularly selectivity in accordance with an example embodiment.

FIG. 2 is schematic diagram of an apparatus for the fabrication of the transparent polymer film and/or plate with broadband angularly selectivity accordance with an example embodiment.

FIG. 3A is a Scanning Electron Microscopy (SEM) image of a film having micro-louvre structures formed with a method in accordance with an example embodiment.

FIG. 3B is an Atomic Force Microscopy (AFM) image of a film having micro-louvre structures formed with a method in accordance with an example embodiment.

FIG. 4 shows transparence change of images by placing the film at different angles with respect to the light source in accordance with an example embodiment.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit example embodiments or their uses. Furthermore, there is no intention to be bound by any theory presented in the preceding background or the following detailed description. It is the intent of the present embodiments to present unique methods and apparatus to improve fabrication of transparent polymer films and/or plates with broadband angular selectivity.

One example embodiment is method that makes transparent polymer films and/or plates (film/plate) with broadband angularly selectivity. The microstructure or micro-louvre structure of the polymers is fast formed during the photopolymerization process. This process enables fabrication of a large area of the angularly selective polymer film/plate with low cost. No mould and/or lithography facilities are required, and the selective angles of the micro-louvres can be easily tuned during the photopolymerization process.

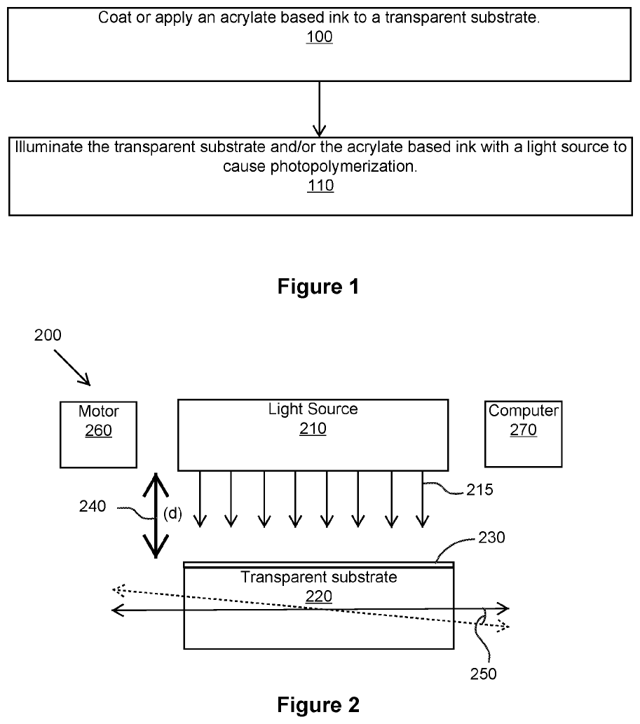

FIG. 1 is a method to fabricate a transparent polymer film and/or plate with broadband angularly selectivity in accordance with an example embodiment.

Block 100 states coat or apply an acrylate based ink to a transparent substrate. Examples of a transparent substrate include, but are not limited to, glass, poly(methyl methacrylate) (PMMA) films and plates, transparent polymeric films and plates, or similar substrates. Examples of an acrylate based ink include, but are not limited to, a mixer of the following competents such as Methyl methacrylate, Di(ethylene glycol) diacrylate, Tetrahydrofurfuryl methacrylate, Tert-butyl acrylate, 1,6-Hexanediol diacrylate, Bisphenol A diglycidyl ether methacrylate, t-butyl alcohol, chlorobenzene, n-propyltriethoxysilane, tetraethyl orthosilicate, tetrapropyl orthosilicate.

Further, examples of the polymeric substrate include, but are not limited to, substrates similar as the transparent substrate that include poly(methyl methacrylate) (PMMA) films and plates, transparent PC films and plates, or transparent silicone films and plates.

The acrylate ink can be applied to a top surface of the substrate or sandwiched between substrates or surfaces. For example, liquid acrylate ink is filled into inter-layers of two glass slides or two PMMA plates.

Block 110 states illuminate the transparent substrate and/or the acrylate based ink with a light source to cause photopolymerization.

Photopolymerization is a process that uses light (e.g., visible or ultraviolet (UV) light) to initiate and to propagate a polymerization reaction that forms a linear or crosslinked polymer structure. Photopolymers or light-activated resins are polymers that change one or more of their structural or physical properties when exposed to light, such as a polymer hardening or solidifying.

Consider an example embodiment in which the polymer film has a range of 1-300 μm, determined and controlled by its resin supporting structures. A space between the polymer film and light source has a range of 1 cm to around 50 cm, determined by the curing speed and the power of the light source. Also, both UV light and laser in the wavelength range from 250-410 nm can be used for the polymer curing.

Due to the spontaneously phase separation and light diffraction, micro-structures like grating can be built-in the formed transparent polymer film. Due to the spontaneously phase separation and light diffraction, part of the acrylates will be first solidified which accelerates the phase separation. This leads to the formation of the micro-structures, like grating in the formed transparent polymer film.

The grating spacing can be tuned by changing the space between the light source and the polymer film. In addition, the selective diffraction angle can be adjusted by changing the relative position of the light source and the film. Because the whole process does not need lithography facilities and patterned micro-structures, a large area of the film/plates can be fabricated with a low cost as compared to traditional fabrication techniques.

FIG. 2 is an apparatus for the fabrication of the transparent polymer film and/or plate with broadband angularly selectivity in accordance with an example embodiment.

The apparatus 200 includes a light source 210 that emits light 215 onto a transparent substrate 220 having one or more surfaces coated with an acrylate based ink 230.

A distance 240 between the light source 210 and the transparent substrate 220 and/or acrylate based ink 230 is adjustable. In addition to the distance, angles 250 of the incident light onto the transparent substrate and/or acrylate based ink are also adjustable.

The distance and the angle can be adjusted with, for example, an electric motor and/or actuator 260 connected to the light source 210 and/or platform on which the transparent substrate 220 rests. The process of measuring and adjusting the distance and angles can be controlled with one or more electronic devices and/or computers 270.

Consider the following example method of fabricating the polymer film and/or plate by adjusting the distance and/or angle.

First, the acrylate 230 is applied to one or more surfaces of the transparent substrate 220. For example, an acrylate film is applied or coated to an outer surface of the substrate, placed between two substrate surfaces, or filled into a cavity, recess, or opening.

Second, the coated and/or filled acrylate film 230 along with the transparent substrate 220 are placed in proximity to the light source 210. For example, the substrate and acrylate film are positioned parallel to the plan of UV lamps.

The angle 250 between the light source 210 and substrate and/or acrylate is measured and adjusted (if needed).

The distance (d) 240 between the light source 210 and substrate and/or acrylate are measured and adjusted (if needed).

The distance and/or angle are then set or fixed based on one more factors. Such factors include, but are not limited to, the selective angle and the angle range, the film transparency, and the dimension of the formed microstructures.

Third, the light source 210 turns on, and the acrylates start photopolymerization. This process can endure for several minutes. The length of time depends, for example, on the thickness of the film and/or the light source. For example, a thinner film has less polymerization time than a thicker film exposed to the same light source. Consider an example embodiment in which a substrate with a film having a thickness of around 2 mm requires around 10 minutes to fully solidify.

Consider the following example for collection of evidences of formation of the micro-louvre structure inside transparent angularly selective polymer film and plate. The acrylate ink is photopolymerize for a few seconds (e.g. 1-3 seconds), and the formed film is washed with acetone to remove any un-reacted monomers and agents. The resulting films are dried and now include micro-louvre structures on the surface.

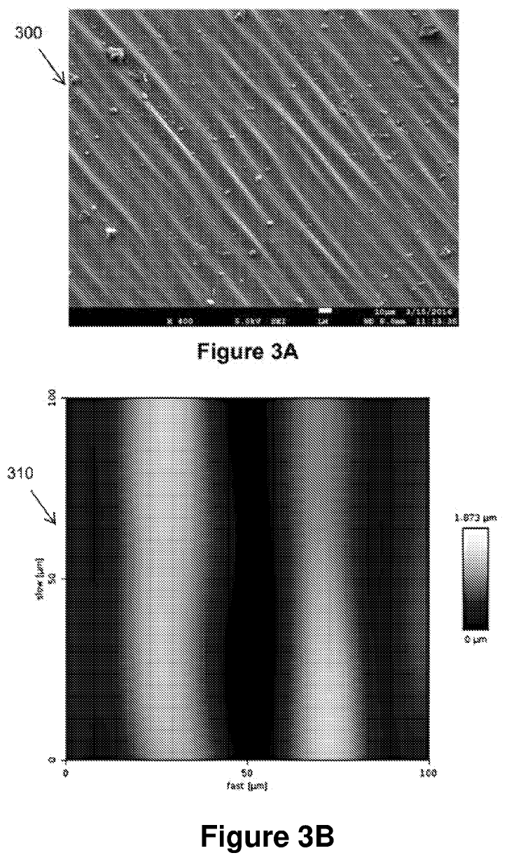

FIG. 3A is a Scanning Electron Microscopy (SEM) image 300 of a film having micro-louvre structures formed with a method in accordance with an example embodiment.

FIG. 3B is an Atomic Force Microscopy (AFM) image 310 of a film having micro-louvre structures formed with a method in accordance with an example embodiment.

The SEM image 300 and AFM image 310 in FIGS. 3A and 3B show the micro-louvre structures were formed at early polymerization stage, with the space in the range of 10-25 μm and height of 1.5-2.5 μm.

The spacing between the micro-louvre structures can be tuned by the distance (d) between the light source and the polymer film. The shorter the distance, the narrower the spacing (l). For instance, a narrow spacing at around l=15 μm was found when the distance is about d=10 cm; while the spacing increased to l=20 μm when the distance is about d=16 cm. As described above, in general, the spacing can be changed in the range of 10 μm to 50 μm with the distance (d) change from 5 cm to around 30 cm.

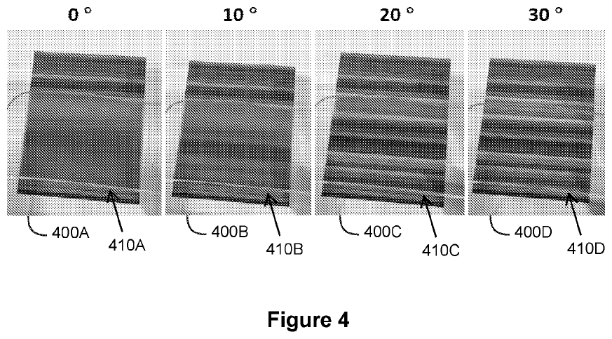

FIG. 4 shows transparence change of images by placing the film at different angles with respect to the light source in accordance with an example embodiment.

Image 400A shows transparence change with the film 410A placed at an angle of 0°; image 400B shows transparence change with the film 410B placed at an angle of 10°; image 400C shows transparence change with the film 410C placed at an angle of 20°; and image 400D shows transparence change with the film 410D placed at an angle of 30°.

These images illustrate an optical angularly selective phenomena by using the fabricated film above a rainbow color image in accordance with an example embodiment.

As shown in FIG. 4, when the film is place parallel to the image (0°), the image becomes blurred. By contrast, when the film is placed above the image with an angle around 30°, the image becomes totally transparent.

An example embodiment in accordance with the invention includes a method to tune the selective angles of the incident light on the polymer film. By changing the relative position of the light source and the polymer film, an example embodiment achieves the film with various change angles. The totally transparent angles can be changed from 60° to 5°.

Variation of the distance and/or angle enable example embodiments to tune the spacing and angles of the micro-louvre structures. Formation of these micro-louvre structures during polymerization in the resulting film/plate is faster and cheaper than conventional lithography techniques.

Example embodiments have a wide range of commercial, industrial, and consumer applications. Examples of such applications include, but are not limited to, fabrication of privacy screens (e.g., used over displays of computer, TVs, and other electronic devices), smart windows, high efficiency solar conversion, detectors with high signal-to-noise ratios, et al.

In some example embodiments, the methods illustrated herein can be executed with one or more electronic devices and/or computers. Further, the data and instructions associated therewith can be stored in respective storage devices that are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes. Such computer-readable or machine-readable medium or media is (are) considered to be part of an article (or article of manufacture). An article or article of manufacture can refer to a manufactured single component or multiple components.

Blocks and/or methods discussed herein can be executed and/or made by a software application, an electronic device, a computer, firmware, hardware, a process, a computer system, and/or an engine (which is hardware and/or software programmed and/or configured to execute one or more example embodiments or portions of an example embodiment). Furthermore, blocks and/or methods discussed herein can be executed automatically with or without instruction from a user.

While exemplary embodiments have been presented in the foregoing detailed description of the present embodiments, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing exemplary embodiments of the invention, it being understood that various changes may be made in the function and arrangement of steps and method of operation described in the exemplary embodiments without departing from the scope of the invention as set forth in the appended claims.

What is claimed is:

1. A method to make a transparent polymer film, the method comprising:
coating a transparent polymeric substrate with an acrylate ink;
adjusting a distance between a light source and the transparent polymeric substrate; and
illuminating the transparent polymeric substrate and the acrylate ink with the light source to cause photopolymerization that creates the transparent polymer film with micro-louvre components inside the transparent polymer film.

2. The method of claim 1 further comprising:
changing the distance between the light source and the transparent polymeric substrate to change a grating spacing of the micro-louvre components.

3. The method of claim 1 further comprising:
changing an angle between the light source and the transparent polymeric substrate to change a diffraction angle of the micro-louvre components.

4. The method of claim 1 further comprising:
placing the transparent polymeric substrate substantially parallel to the light source with the distance being from 1 cm to 50 cm.

5. The method of claim 1, wherein the transparent polymeric substrate is illuminated for around 10 minutes to solidify the transparent polymer film with a thickness of around 2 mm.

6. The method of claim 1, wherein the micro-louvre components have a space in a range of about 10 μm-25 μm and a height of about 1.5 μm to about 2.5 μm.

7. The method of claim 1 further comprising:
adjusting the distance to about 10 cm to create the micro-louvre components with a space of around 15 μm.

8. The method of claim 1 further comprising:
adjusting the distance to about 16 cm to create the micro-louvre components with a space of around 20 μm.

9. A method to make a transparent polymer plate, the method comprising:
applying an acrylate ink to a glass substrate; and
illuminating the glass substrate and the acrylate ink with a light source to cause photopolymerization that creates the transparent polymer plate with micro-louvre structures inside the transparent polymeric plate.

10. The method of claim 9 further comprising:
fixing a distance between the light source and the glass substrate to a distance from 1 cm to 50 cm.

11. The method of claim 9, wherein the light source generates ultraviolet (UV) light with a wavelength in a range of about 250 nm-410 nm.

12. The method of claim 9, wherein the transparent polymer plate has a height of about 1 μm to about 300 μm.

13. The method of claim 9, wherein the micro-louvre structures have a width, a height, and a distance from each other of about 5 μm to about 50 μm.

14. A transparent polymer film fabricated from a method comprising:
applying an acrylate ink to a Poly(methyl methacrylate) (PMMA) substrate;
adjusting a distance between a light source and the PMMA substrate;
adjusting an angle between the light source and the PMMA substrate; and
illuminating the PMMA substrate and the acrylate ink with the light source to cause photopolymerization that forms micro-louvre components inside the PMMA substrate.

15. The transparent polymer film of claim 14, wherein the PMMA substrate is a privacy plate for a screen of an electronic device.

16. The transparent polymer film of claim 14, wherein the micro-louvre components have a space in a range of about 10 μm-25 μm and a height of about 1.5 μm to about 2.5 μm.

17. The transparent polymer film of claim 14, wherein the micro-louvre components have a space around 15 μm when the distance is around 10 cm.

18. The transparent polymer film of claim 14, wherein the micro-louvre components have a space around 20 μm when the distance is around 16 cm.

19. The transparent polymer film of claim 14, wherein the distance is between about 1 cm to about 50 cm.

20. The transparent polymer film of claim 14, wherein the angle between the light source and the PMMA substrate adjusts to change a diffraction angle of the micro-louvre components.
